(19) United States
(12) Patent Application Publication
(10) Pub. No.: US 2008/0259327 A1
(43) Pub. Date: Oct. 23, 2008

(54) Device for Inspecting a Microscopic Component

(75) Inventors: Hans-Juergen Brueck, Muenchen (DE); Gerd Scheuring, Muenchen (DE); Frank Hillmann, Deggendorf (DE); Hans-Artur Boesser, Breidenbach (DE)

Correspondence Address: HOUSTON ELISEEVA, 4 MILITIA DRIVE, SUITE 4, LEXINGTON, MA, 02421, US

(73) Assignee: VISTEC SEMICONDUCTOR SYSTEMS GMBH, Wetzlar (DE)

(21) Appl. No.: 11/569,172

(22) PCT Filed: Jul. 5, 2005
(86) PCT No.: PCT/EP05/53212

§ 371 Date: Jun. 27, 2008

(30) Foreign Application Priority Data
Jul. 9, 2004 (DE) 10 2004 033 195

(51) Int. Cl. G01N 21/956; G02B 21/26

(52) U.S. Cl. 356/237.5; 359/392

(57) ABSTRACT

A device 1 is disclosed for inspecting, measuring defined structures, simulating structures and structural defects, repair of and to structures, and post-inspecting defined object sites on a microscopic component 2 with an immersion objective 8a. The device 1 comprises a stage that is movable in the x-coordinate direction and in the y-coordinate direction and a holder 42 for the microscopic component 2, whereby the holder 42 is placed on the stage 4 with the microscopic component 2 in it. The holder 42 has a reservoir 51a with immersion or cleaning fluid, respectively. The stage 4 is movable such that the immersion objective 8a is located directly above the reservoir 51a and may dip into the fluid with its front-most lens.

### RELATED APPLICATIONS

This application is a National Stage application of PCT application serial number PCT/EP2005/053212 filed on Jul. 5, 2005, which in turn claims priority to German application serial number 10 2004 033 195 filed on Jul. 9, 2004.

### FIELD OF THE INVENTION

The invention relates to a device for inspecting a microscopic component. In particular, the invention relates to a device for inspecting a microscopic component with a stage for the microscopic component, at least one objective that is implemented as an immersion objective, and which defines an imaging beam path.

### BACKGROUND OF THE INVENTION

The term inspection is understood here as meaning all activities that can occur in the context of the control of microscopic components. These include, for example, in addition to pure inspection, measurement of defined structures, simulation of structures and structural errors, repair of and to structures, and post-inspection of defined object positions. A person skilled in the art refers to this process as review.

European patent application 1 420 302 A1 discloses a lithography device and a method for producing a component using the lithography device. An immersion objective is used to increase resolution, and the immersion fluid is applied to the surface of the substrate to be structured. The entire table with the substrate to be structured is covered with a fluid. To avoid turbulence in the fluid, a transparent pan is dipped in the fluid. The pan is provided with the same fluid in which the imaging objective is dipped. This device is not suitable for inspecting masks, wafers, or components of a similar type.

The publication of US patent application 2004075895 discloses a device and a method for immersion lithography. The wafer to be structured is covered completely with a fluid. There is a small space between the imaging optic and the wafer such that only a small quantity of fluid is present therein. The fluid is constantly pumped, filtered, and also replenished.

None of the devices according to the state of the art suggest using an immersion objective or applying the immersion fluid directly to the microscopic component to be inspected (mask, wafer, micromechanical component).

### SUMMARY OF THE INVENTION

The object of the present invention is therefore to increase the resolution of the inspection device, while simultaneously avoiding contamination of the components to be inspected.

According to the invention, this object is solved by a device for inspecting with the characteristics in claim 1.

It is of advantage if the device for inspecting a microscopic component has at least one objective that is implemented as an immersion objective. Furthermore, the device is provided with a device for applying a small dosed quantity of fluid to the surface of the microscopic component. Likewise, a device for suctioning the small quantity of fluid is positioned above the surface of the microscopic component, whereby the device at least partially surrounds the immersion objective, or whereby it is arranged in the vicinity of the objective. The small quantity of fluid is a drop of fluid that represents the immersion fluid. It is particularly advantageous to use water as the immersion fluid. Highly purified water is recommended as the immersion fluid for a number of applications. Consequently, the immersion objective is a water immersion objective. The device may also be operated with other immersion fluids that are described in the literature.

In order to achieve high resolution, a portion of the light for inspecting with an immersion objective should have a wavelength of 248 nm or shorter (e.g., 193 nm). The several objectives may be mounted to a turret. Likewise, a fixed arrangement of two or several objects to each other is also conceivable, whereby one objective is the immersion objective, and the other(s) is/are used for alignment and other inspectional tasks using visible light.

The arrangement of the device for suctioning a small quantity of fluid is provided with a multiplicity of suction nozzles on the surface of the opposite side of the microscopic component. The suctioning nozzles comprise an edge and a suction channel, whereby the edge is at a controlled distance of less than 300 μm from the surface of the microscopic component. Furthermore, the device has for the purpose of suctioning a prominence on the side that is opposite the surface of the microscopic component, on which the suction nozzles are arranged such that the individual suction nozzles jut out over the prominence. The prominence is implemented in the present embodiment. For the suction device to function, it is simply required that the nozzles themselves be elevated.

Further advantages and advantageous embodiments of the invention are the subject of the following figures and their descriptions.

### BRIEF DESCRIPTION OF THE DRAWINGS

The object of the invention is schematically represented in the diagram and is described on the basis of the figures below. They show:

FIG. 1—a schematic design of the device for inspecting and/or measuring, simulating, and repairing a microscopic component;

FIG. 2—a schematic view of several objectives are arranged on a turret and their allocation to the microscopic component to be inspected;

FIG. 3—a schematic view of an immersion objective in the working position;

FIG. 4—a schematic view of the method of the device for suctioning to enable shifting of the immersion objective from the working position;

FIG. 5—a further schematic representation of an embodiment of the suction device;

FIG. 6—a schematic representation of an embodiment of the invention from FIG. 6 along the A-A line of intersection;

FIG. 7—a bottom view of the device for inspecting a microscopic component, whereby the area around the suction device is represented;

FIG. 8—a bottom view of the device for inspecting a microscopic component, whereby the area around the suction device is represented and other elements from the area around the objective are extended;

FIG. 9—a detailed perspective view of the area around the objective and the microscopic component;

FIG. 10—a schematic representation of a further embodiment of the device for inspecting and/or measuring a microscopic component, whereby two objectives that are fixedly arranged in relation to each other are provided;

FIG. 11—a perspective top view of an embodiment of the device for suctioning the small quantities of fluid;

FIG. 12—a perspective bottom view of an embodiment of the device for suctioning the small quantities of fluid;

FIG. 13—a bottom view of the embodiment in FIG. 11;

FIG. 14—a lateral view of the embodiment in FIG. 11;

FIG. 15—a sectional view along the line B-B in FIG. 13;

FIG. 16—a schematic view of the arrangement of the suction nozzles;

FIG. 17—a further schematic view of the arrangement of the suction nozzles;

FIG. 18—a schematic view of the switching the various segments of the U-shaped suction device;

FIG. 19—an embodiment of the segmentation of a square device for suctioning; and

FIG. 20—a further embodiment of the segmentation of a ring shaped device for suctioning.

### DETAILED DESCRIPTION OF THE PREFERRED EMBODIMENTS

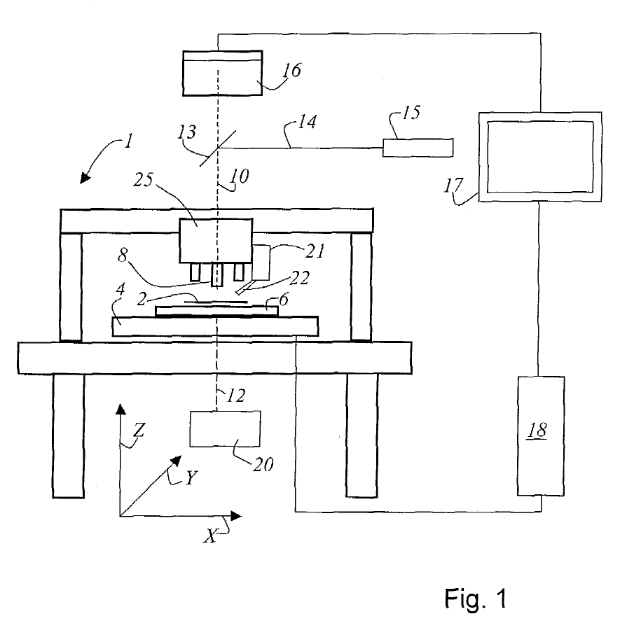

FIG. 1 shows a schematic design of a device 1 for inspecting a microscopic component 2. A stage 4 that is implemented as a scanning table is provided for the microscopic component 2 on the basic frame 3. The stage 4 is movable in an x-coordinate direction and in a y-coordinate direction. The microscopic component 2 to be inspected is placed on the stage 4. The microscopic component 2 may be held in an additional holder 6 on the stage 4. The microscopic component 2 is a wafer, a mask, several micromechanical components on a substrate, or a component of related type. At least one objective 8, which defines an imaging beam path 10, is provided for imaging the microscopic component 2. The stage 4 and the additional holder 6 are implemented such that they are suitable both for incident light illumination and also for transmitted light illumination. For this purpose, the stage 4 and the additional holder 6 are implemented with a recess (not depicted) for passage of an illumination light path 12. The illumination light path 12 exits from a light source 20. A beam splitter 13 that couples or outcouples an auxiliary beam for focusing 14 is provided in the imaging beam path 10. The focal position of the microscopic component is determined or measured, as the case may be, by a detection unit 15 with which the distance between the surface of the microscopic component to the objective and the devices for applying and removing the immersion fluid may be controlled. A CCD camera 16 is provided behind the beam splitter 13 in the imaging beam path 10, with which the image of the site on the microscopic component 2 that is to be inspected can be recorded or imaged. The CCD camera 16 is connected to a monitor 17 and a computer 18. The computer 18 serves to control the device 1 for inspecting, for processing the image data that has been captured, and for storing the pertinent data, as well as for controlling the application and suctioning of immersion fluid. In the embodiment of the invention represented here, several objectives 8 on a turret (not depicted) are provided such that a user may select various enlargements. System automation is achieved using the computer 18. In particular, the computer serves to control the stage 4, to read out the CCD camera 16, to apply a small quantity of fluid to the microscopic component 2, and to drive the monitor 17. The stage 4 is movable in an x-coordinate direction and a y-coordinate direction; the X-coordinate direction and a y-coordinate direction are perpendicular to each other. In this manner, each site on the microscopic component 2 that is to be inspected may be introduced into the imaging beam path 10. The device 1 for inspecting a microscopic component 2 further comprises a device 21 for applying a small quantity of fluid to the microscopic component 2. A nozzle 22 is provided to apply the small quantity of fluid, and which may be moved in an appropriate manner to precisely the site where the small quantity of fluid is to be applied.

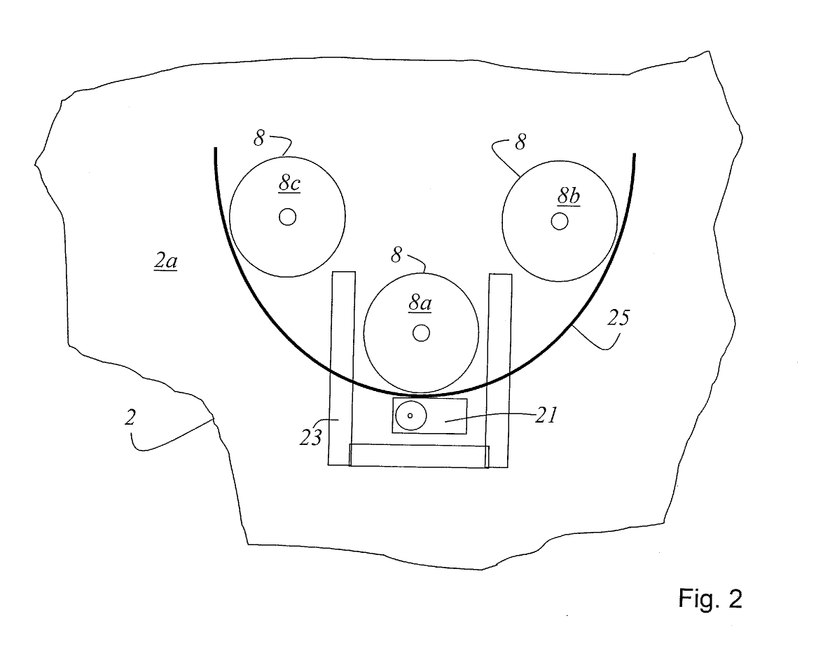

FIG. 2 shows a schematic view of several objectives 8 that are mounted to a turret 25. The objectives 8 may be moved into the imaging beam path 10, depending on the desired method of inspection. One of the several objectives 8 on the turret is an immersion objective 8a; in addition, there is a dry objective 8b (not an immersion objective) and an alignment objective 8c. A turret 25, which holds the various objectives 8, is mounted above the microscopic component 2 to be inspected. In the diagram represented here, the immersion objective 8a is in the working position and is provided opposite the surface 2a of the microscopic component 2. In addition, a device 21 for applying a small dosed quantity of fluid to the surface 2a of the microscopic component 2 is allocated to the immersion objective 8a. In addition, a device 23 is mounted for suctioning the small quantity of fluid above the surface 2a of the microscopic component 2. The device 21 for applying the fluid is arranged closer to the immersion objective 8a than is the suctioning device 23. In the embodiment of the invention represented here, the suctioning device 23 is implemented such that it at least partially surrounds the immersion objective 8a.

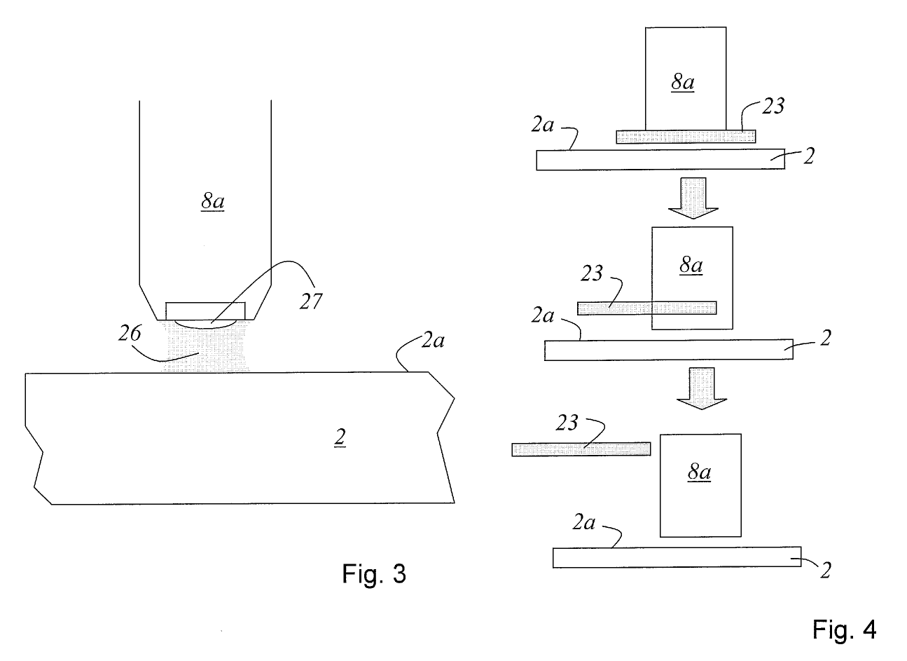

FIG. 3 shows a schematic view of the immersion objective 8a in the working position. A small quantity of fluid 26 is applied between the immersion objective 8a and the surface 2a of the microscopic component 2. In the process, the small quantity of fluid 26 completely wets the front-most lens 27 of the immersion objective 8a.

FIG. 4 shows a schematic view of the method of the suction device 23 in order to enable shifting of the immersion objective 8a from the working position. A device 23 for suctioning the small quantities of fluid are provided opposite the surface 2a of the microscopic component 2. As previously detailed, the suction device 23 partially surrounds the objective 8a. Embodiments are also feasible in which only one suction device is arranged next to the objective. In order to enable shifting of the objective, the suction device 23 must be moved out of the area of linear or pivoting movement of the objective. The suction device 23 is moved as indicated by an arrow 30 in FIG. 4. The suction device 23 is no longer in the area of the objective, as is evident from the bottom diagram in FIG. 4.

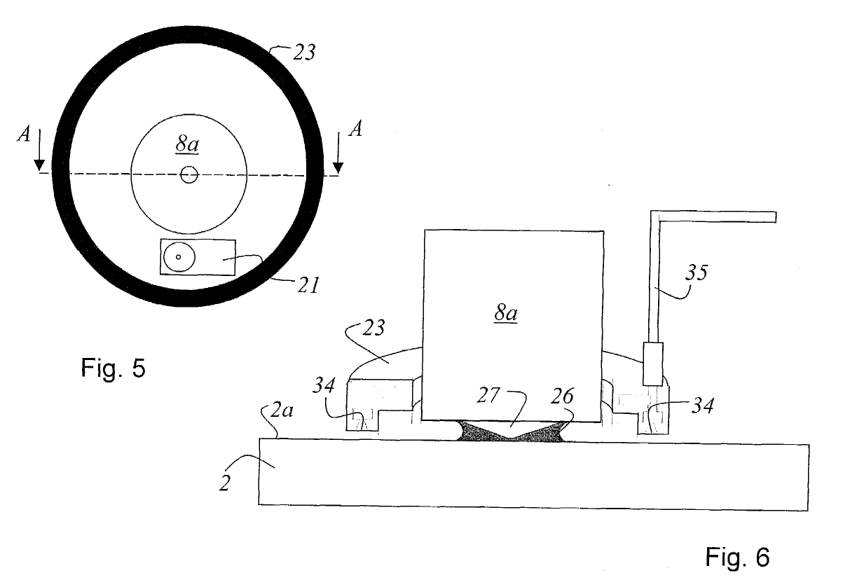

FIG. 5 shows a further schematic representation of an embodiment of the suction device 23. Here, the immersion objective 8a is completely surrounded by the suction device 23. The suction device 23 is implemented in the shape of a ring. It will be obvious to a person skilled in the art that the suction device 23 may assume any closed or open shape in order to at least partially surrounds the immersion object 8a. Within the suction device 23, a device 24 for applying a small quantity of fluid to the microscopic component 2 is also provided.

FIG. 6 is a schematic representation of the embodiment in FIG. 5 along the A-A line of intersection. The immersion objective 8a is arranged opposite the surface 2a of the microscopic component 2. A small quantity of fluid 26 is applied between the front-most lens 27 of the immersion objective 8a and the surface 2a of the microscopic component 2. The immersion objective 8a is surrounded by the suction device 23. The suction device 23 is implemented with several openings 34 on a side 32 that is opposite the surface 2a of the microscopic component 2. The fluid from the surface 2a of the microscopic component 2 may be suctioned off as needed through these openings 34. The suction device 23 is connected to a negative pressure reservoir (not depicted) via a tubing 35. The fluid is suctioned from the surface 2a by applying negative pressure.

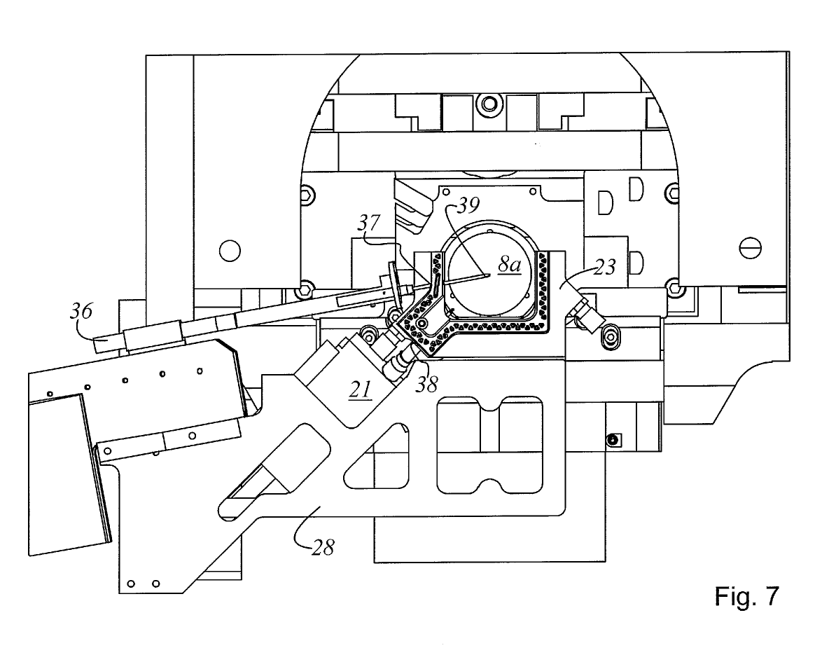

FIG. 7 shows a bottom view of the device for inspecting a microscopic component 2, whereby the area around the suction device 23 is represented. The suction device 23 is allocated to the immersion objective 8a. In the embodiment represented here, the suction device 23 is implemented in a U-shape. Although the following description is limited to a U-shaped suction device 23, this should not be interpreted as a limitation of the invention. The suction device 23 is mounted to a carrier 28. The carrier 28 is movably implemented such that the suction device 23 may be moved out of the area of linear or pivoting movement of the objective 8a, and the distance to the surface of the microscopic component can be controllably adjusted. Furthermore, a device 21 for applying a small quantity of fluid and a cleaning device 36 are provided on the carrier 8a. The cleaning device 36 serves to remove reliably from the objective 8a any fluid that still adheres to it. The application device 21 and the cleaning device 36 are positioned in the area around the immersion objective 8a by corresponding recesses 37 and 38 in the suction device 23. The cleaning device 36 comprises a nozzle tip 39 with which residual fluid that adheres to the immersion objective 8a may be suctioned off.

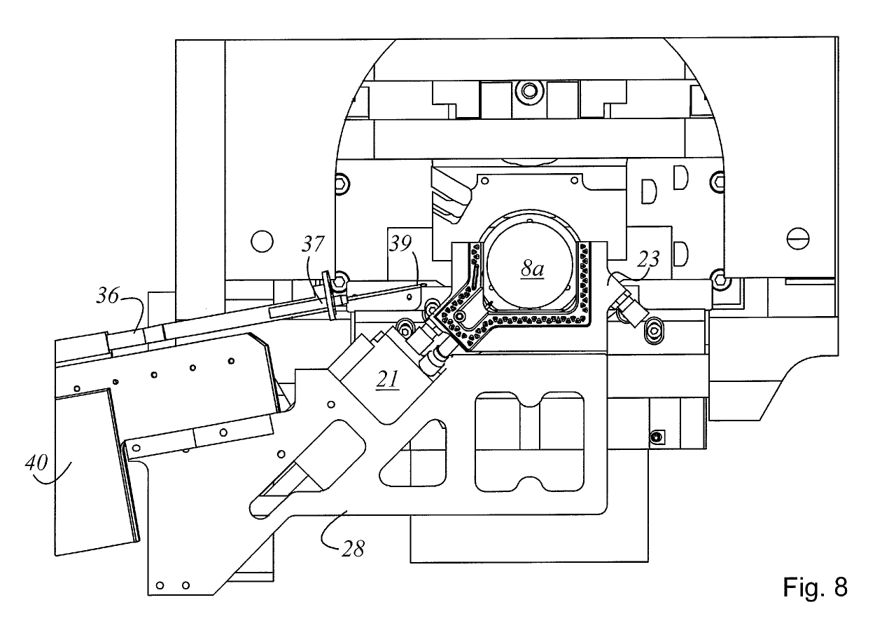

FIG. 8 is a bottom view of the device for inspecting a microscopic component 2, whereby the area around the suction device 23 is represented, and further elements are extended beyond the area around the objective 8a. As previously mentioned, the further elements are the suction device 23 and the cleaning device 36. As previously described in FIG. 4, the objective can only be shifted when the cleaning device 36 is completely extended beyond the suction device 23. The cleaning device 36 is movably implemented and is mounted for the purpose to a corresponding movable mimic 40.

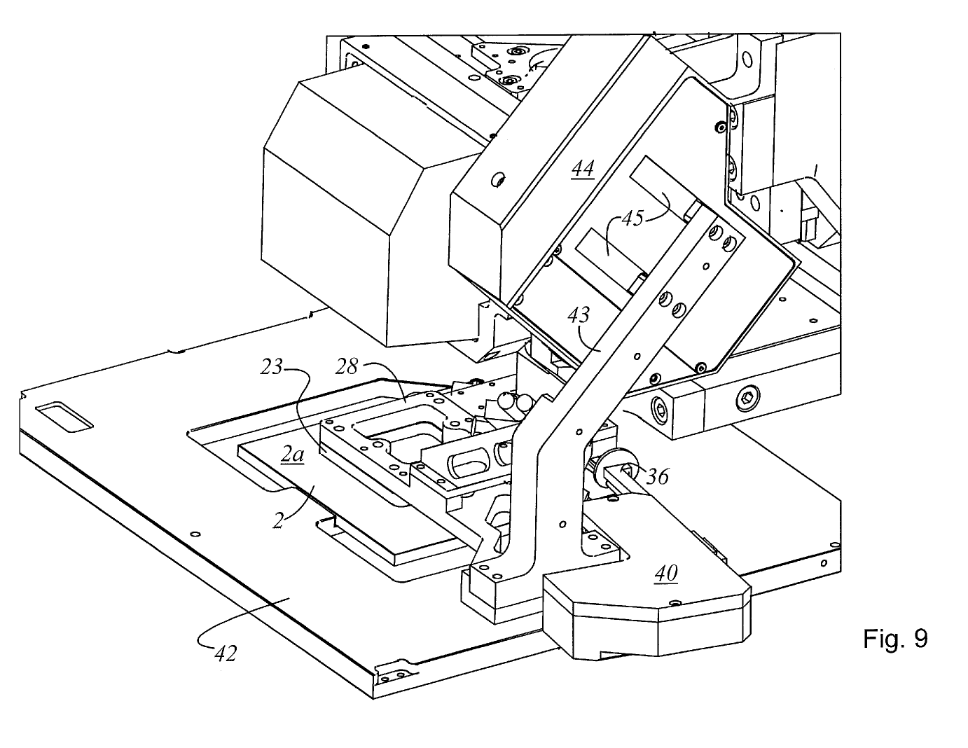

FIG. 9 shows a detailed perspective view of the area around the objective 8, 8a, and the microscopic component 2. The device 21 for applying a small quantity of fluid to the microscopic component 2 and the cleaning device 36 are attached to the mimic 40, which is movably implemented. The device 23 for suctioning small quantities of fluid is provided in the working position directly opposite the surface 2a of the microscopic component 2. In the embodiment represented in FIG. 9, the microscopic component 2 is a mask for producing semiconductors. Here, the mask is positioned in a separate mask holder 42. The carrier 28 is mounted via a rigid arm 43 to a lifting device 44, which lifts the carrier 28 together with the suction device 23 from the surface 2a of the microscopic component 2. The arm 43 on the lifting device 44 is movable for the purpose in the direction of two elongated holes 45.

FIG. 10 is a schematic representation of a further embodiment of the device for inspecting and/or measuring a microscopic component 2. Here, the turret 25 is replaced by two objectives 8, 8a that are fixedly arranged in relation to each other. One of the objectives is an immersion objective 8a that is implemented and intended for DUV illumination (248 nm or 193 nm). The second objective 8 is an objective for visible light that can be used for alignment or other inspectional tasks. Each of the objectives is allocated at least one CCD 48, which is used for capturing images. The microscopic component 2 in this case is a mask, the substrate of which is transparent. An illumination optic 46 is provided below the mask for illumination.

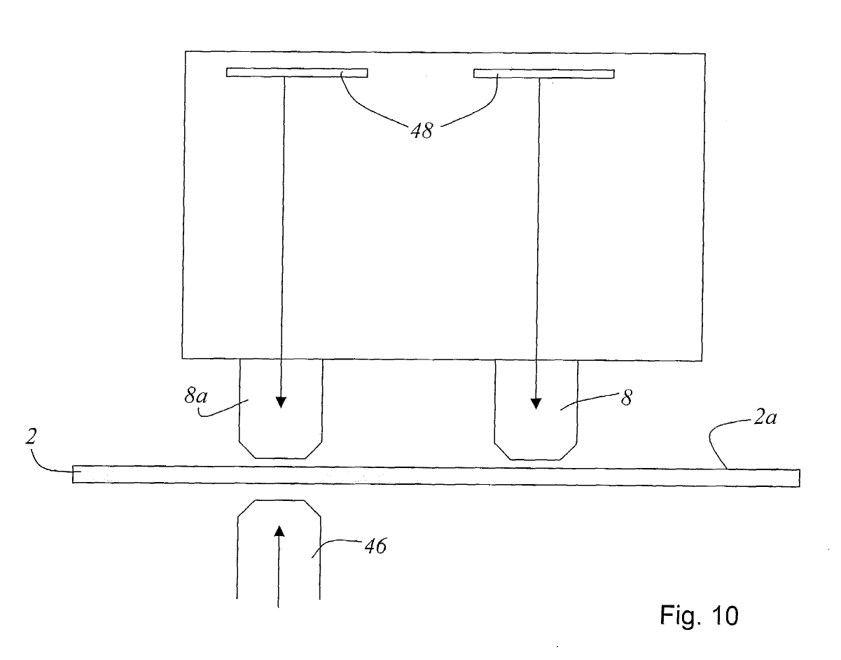

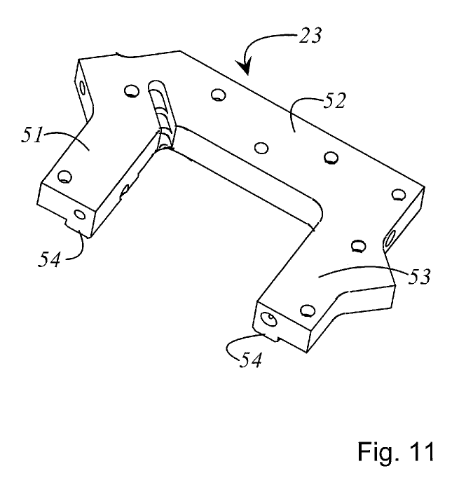

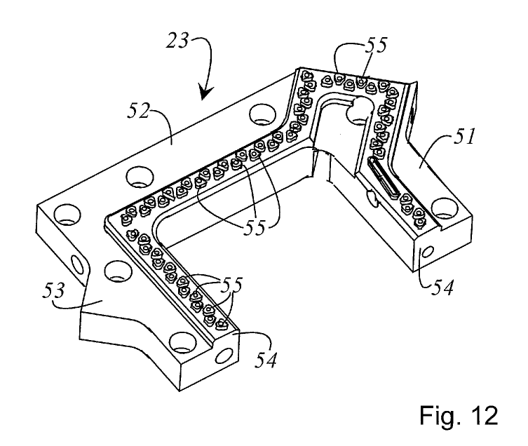

FIG. 11 is a perspective top view of an embodiment of the device 23 for suctioning small quantities of fluid. The suction device 23 in this embodiment is implemented in a U-shape and comprises a first leg 51, a second leg 52, and a third leg 53 the suction device 23 exhibits a prominence 54 on the side opposite the microscopic component 2, in which the suction nozzles 55 are implemented (see FIG. 12).

FIG. 12 is a perspective bottom view of an embodiment of the device 23 for suctioning small quantities of fluid. The prominence 54 is implemented as a continuous band along the first, second, and third legs 51, 52, and 54. The prominence bears a multiplicity of suction nozzles 55 which, in the working position of the suction device 23, lie opposite to the surface 2a of the microscopic component 2.

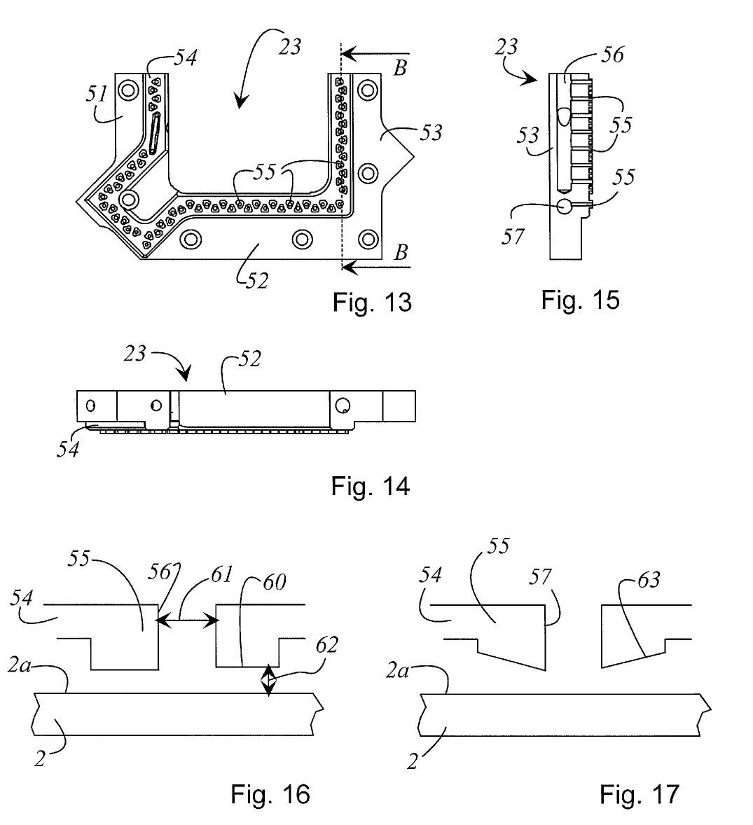

FIG. 13 shows a bottom view of the embodiment of the suction device 23 from FIG. 11. As mentioned previously, the multiplicity of suction nozzles 55 is formed on the prominence 54. The suction nozzles 55 run as a continuous band along the first, second, and third legs. The individual suction nozzles 55 are themselves elevated above the prominence 54. Furthermore, the suction nozzles are staggered. The line B-B in FIG. 13 illustrates the staggering of the suction nozzles 55.

FIG. 14 shows a lateral view of the embodiment of the suction device 23 from FIG. 13. The individual suction nozzles 55 jut above the prominence 54. The arrangement of the individual suction nozzles 55 is staggered such that they form in projection a closed barrier to the immersion fluid to be suctioned. This ensures that no immersion fluid can pass by the suction nozzles 55.

FIG. 15 shows a sectional view of the suction device 23 along the B-B line from FIG. 13. The individual suction nozzles 55 of the third leg 53 are connected with a suction channel 56. Likewise, the suction nozzles 55 of the second leg 52 are connected with a further, separate suction channel 57. As a result of this separation of the suction channels, it is possible to pressurize the individual legs 51, 52, and 53 with negative pressure.

FIG. 16 is a schematic view of the embodiment of the suction nozzles 55. The suction nozzles 55 are formed with an edge 60 that is additionally elevated above the prominence 54. The suction channels 56, 57 of the suction nozzles 55 have a diameter 61 of approximately 1 mm. The edge 60 is arranged parallel to the surface 2a of the microscopic component 2 (mask). The edge 60 is positioned at a controlled distance of less then 300 μm from the surface 2a.

FIG. 17 shows a further schematic view of the design of the suction nozzles 55. The suction channel 57 of the suction nozzle 55 comprises a slanted edge 63, so that the distance of the edge 63 increases from the center of the suction channel 57 outwardly in a continuous manner from the surface 2a of the microscopic component 2. This design serves, in particular, to draw immersion fluid by means of capillary action in the direction of the suction channel 57 in order to achieve reliable suctioning of the immersion fluid.

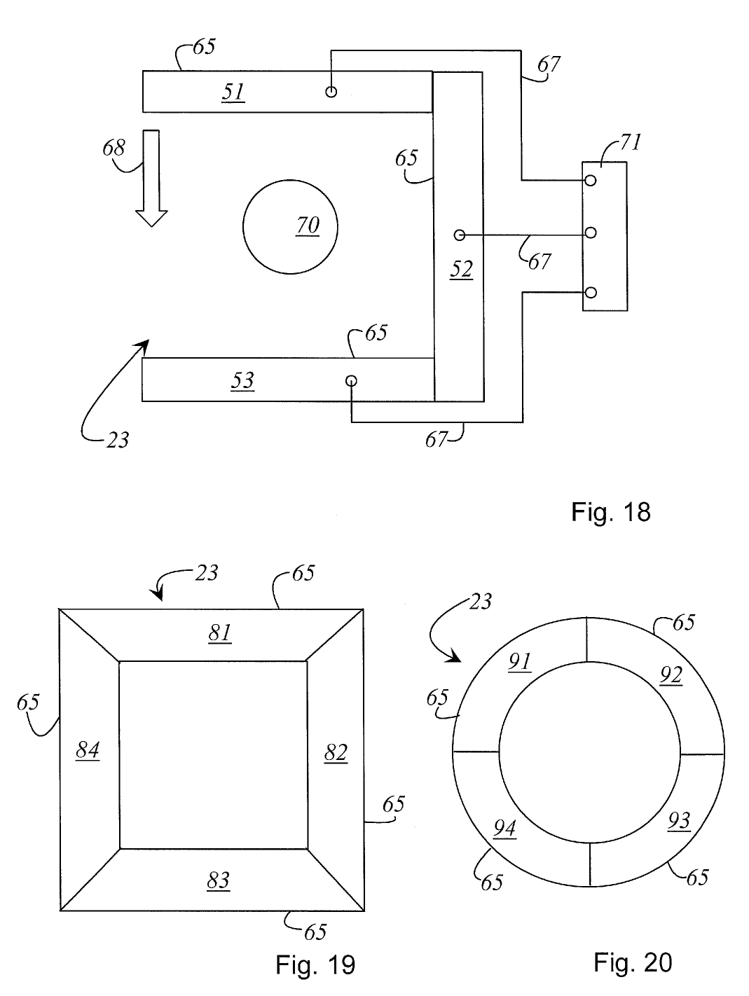

FIG. 18 is a schematic view of the switching of the various segments of the U-shaped suction device 23. The first leg 51, the second leg 52, and the third leg 53 of the U-shaped suction device 23 are separated into discrete segments 65. Each of the segments is provided with its own tubing 67 for applying negative pressure. Negative pressure may be applied to the corresponding segments 65 independent of the relative movement between the stage 4 (see FIG. 1) and the suction device 23. The relative movement between the stage 4 and the suction device 23 is indicated by an arrow 68 in FIG. 18. As a result, the first leg 51 moves toward a drop of fluid 70 such that the segment 65 of the first leg 51 must be pressurized with negative pressure. A control 71 is provided that applies negative pressure to the corresponding leg independent of the direction of movement of the suction device 23. Optimal suctioning is achieved at each segment as a result of this circuitry.

FIG. 19 shows an embodiment of the segmentation of a square suction device 23. The individual segments 65 comprise sides 81, 82, 83, and 84 of the square.

FIG. 20 shows a further embodiment of the segmentation of a round suction device 23. Here, the individual segments 65 are here the orthogonal sectors 91, 92, 93 and 94 of the round suction device 23. It will be clear to a person skilled in the art that another division of the segments 65 is feasible.

1.-26. (canceled)

27. Device 1 for inspecting a microscopic component 2 with an immersion objective 8a, the device 1 comprising a stage 4 in the x-coordinate direction and in the y-coordinate direction and a holder 42 for the microscopic component 2, whereby the holder 42 with the microscopic component 2 that it holds is placed on the stage 4, wherein an immersion fluid is applied between a front-most lens 27 of the immersion objective 8a and a surface 2a of the microscopic component 2, such that the holder 42 has in one place a reservoir 51a with immersion fluid, and whereby the stage 4 is movable such that the immersion objective 8a is located at the site of the reservoir 51a and dips into the fluid contained in the reservoir 51a.

28. Device 1 according to claim 27, wherein the reservoir 51 is formed as a depression in the holder 42, and the depression is coated with a hydrophobic layer.

29. Device 1 according to claim 27, wherein the hydrophobic layer consists of Teflon.

30. Device according to claim 27, wherein the microscopic component 2 is a mask, on the surface 2a of which structures are formed.

31. Device according to claim 27, wherein the microscopic component 2 is a wafer that has a surface 2a on which structures are formed.

32. Device according to claim 27, wherein the microscopic component 2 is a substrate that bears, among other things, a multiplicity of micromechanical elements on a surface 2a.

33. Device according to claim 27, wherein the small quantity of fluid 26 is a drop of fluid that represents the immersion fluid, and wherein the immersion fluid is water, and wherein the immersion objective 8a is a water immersion objective.

34. Device according to claim 33, wherein a portion of the light for inspecting the immersion object 8a has a wavelength of 248 nm.

35. Device according to claim 27, wherein a device 21 for applying small doses of quantities of fluid to the surface 2a of the microscopic component 2, and wherein a device 23 for suctioning the small quantity of fluid on the surface 2a of the microscopic component 2 are mounted, whereby the suctioning device 23 at least partially surrounds the immersion objective 8a.

36. Device according to claim 27 wherein a cleaning device 36 is provided that is arranged such that it may be retracted and extended in the inside of the suction device 23, and wherein a nozzle tip 39 of the cleaning device 36 penetrates into the fluid quantity between the immersion objective 8a and the surface 2a of the microscopic component 2.

37. Device according to claim 36, wherein in the case of a raised immersion objective 8a, the nozzle tip 39 of the cleaning device 36 penetrates into a fluid bridge 29 formed between the surface 2a of the microscopic component 2 and a front-most lens 27 of the immersion objective 8a and destroys the fluid bridge 29 and/or suctions a portion of the fluid.

38. Device according to claim 37, wherein the nozzle tip 39 of the cleaning device 36 is movable in the area around the front-most lens 27 of the immersion objective 8a in order to remove any residually adherent drop of fluid 30.

39. Device according to claim 27, wherein the device 23 for suctioning the small quantity of fluid on the surface 2a of the microscopic component 2 is provided with a multiplicity of suction nozzles 55 on the opposite side.

40. Device according to claim 39, wherein the suction nozzles 55 are at a distance 62 of 100 μm to 300 μm from the surface 2a of the microscopic component 2.
